(19) United States
(12) Patent Application Publication
(10) Pub. No.: US 2009/0244101 A1
(43) Pub. Date: Oct. 1, 2009

(54) PIXEL LAYOUT FOR DISPLAYS

(75) Inventors: Erno Hermanus Antonius Langendijk, Eindhoven (NL); Michiel Adriaanszoon Klompenhouwer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/721,693

(22) PCT Filed: Dec. 5, 2005
(86) PCT No.: PCT/IB2005/054056

§ 371 Date: Jun. 14, 2007

(30) Foreign Application Priority Data
Dec. 14, 2004 (EP) 04106540.0

(51) Int. Cl. G09G 5/10

(52) U.S. Cl. 345/690

(57) ABSTRACT

An improved subpixel arrangement for pixelated displays, wherein cross-shaped elements comprising a yellow subpixel surrounded by blue subpixels are distributed over the surface of the display. Further red and green subpixels can be arranged such that white light is emitted from three adjacent rows and three adjacent columns of a pixel comprising said cross-shaped element.

A pixelated color display comprises several differently colored subpixels, which are used e.g. to display color images. A subpixel is typically the smallest switchable unit in a display. By controlling the intensity emitted by the different subpixels, color images can be generated by the display. Traditional displays, such as TV screens, comprise three different types of subpixels, and each type is capable of emitting one of the display primary colors red (R), green (G) and blue (B), respectively. These subpixels are grouped into pixels, e.g. such that each pixel comprises one of each subpixel type. A viewer observes a full color pixel, from the primary color contributions of each subpixel.

In the context of this description a pixel is a logical, rather than mechanical unit. The pixel can be seen as a building block, comprising differently colored subpixels, wherein each subpixel has one color, or is able to emit one color. The pixel or building block is repeated over a surface in order to form a display. In other words, a pixel can also be seen as the smallest unit, which alone can form a surface generating full color images, by being repeated over a display surface. Moreover, the intensity of the subpixels is controllable by control signals. Each subpixel can be controlled by a separate control signal, but usually it is advantageous to control several subpixels with the same control signal. The subpixels, which are controlled by the same control signal, might either all belong to the same pixel or to different pixels.

Color is defined as an attribute of visual perception consisting of any combination of chromatic and achromatic content. This attribute can be described by chromatic color names e.g. yellow, orange, brown, red, pink, green, blue, purple, or by achromatic color names e.g. white, grey, black, and qualified by e.g. bright, dim, light, dark or by combinations of such names.

A perceived color depends on the spectral distribution of the color stimulus, on the size, shape, structure and surround of the stimulus area, on the state of adaptation of the observer's visual system, and on the observer's experience of the prevailing and similar situations of observations.

In the retina of the eye there are three different types of light sensors. These sensors are called the L, M and S cones, which are sensitive to light with long (L), medium (M) and short (S) wavelengths, respectively. Each type of sensor is connected with neurons to the brain. When light falls on a cone it will start to send pulses to the brain, if it is sensitive to the wavelength of the light. The more light falls on the cones the quicker they will send the pulses.

The color of the light that enters the eye is determined by the relative amount of pulses that each of the three types of cones sends to the brain. Blue light (wavelength approximately 400-450 nm), for example, results in more spikes from the S cones than from the L cones or the M cones.

Because the human eye has only three types of cones, there are a number of different light spectra that give the same color sensation. For example, sunlight and the light from a fluorescent lamp are both perceived as white in color, but whereas the sunlight has a very broad spectrum with about equal intensity for each wavelength, the fluorescent lamp has a spectrum with only a few peaks. This effect of different light spectra giving the same color sensation is called metamerism, and two spectra which give the same color sensation are called metamers.

Another effect of having only three types of cones is that different colors can be made by adding together the light of two light sources while varying the relative intensity of these light sources. If red light and green light are mixed, it may be perceived as yellow. If a first light source emitting red light is set to full intensity and a second light source emitting green light is set to zero intensity, and the intensity of the green light is increased while the intensity of the red light is decreased, the color changes from red, to orange, to yellow, and finally to green. Displays use this principle to make many colors with only three primary colors; usually red, green and blue.

The human eye does not see each wavelength of light equally bright. The ends of the spectrum are seen as darker than the middle. In other words, a given energy intensity of a green wavelength is perceived to be brighter than that same energy intensity of either red or blue. Further, due to the configuration of the S-cones, blue colors appear even darker than red colors. A blue light must comprise approximately ten times as much energy, compared to green light, in order for the blue light to be perceived as equally bright as the green light.

In order to predict the color sensation that we get from the light that enters our eyes a number of models have been developed. One of these models, which is most commonly known and which is standardized by the CIE (Commission Internationaled'Eclairage-International Commission on Illumination) is the CIE 1931 model. It defines three spectral matching functions for the standard observer that can be used to calculate the tri-stimulus values X, Y, and Z, respectively, for a light with a certain spectrum. The subject matter of color vision is further elucidated in e. g. Roy S. Berns, Fred W. Billmeyer, and Max Saltzman; Billmeyer and Saltzman's Principles of Color Technology, 3rd Edition; ISBN 0-471-19459-X.

In an ideal display it is usually beneficial to be able to generate white light along as many columns and rows of the display as possible, as this can increase the perceived sharpness of the display, without introducing color errors. This is for example used in subpixel rendering methods, wherein an input video/image signal is converted such, that it is mapped to the subpixel lay-out of the display. These methods are generally known to a man skilled in the art.

Conventional RGB-displays use a striped pixel layout, where pixels comprising a one red, one green and one blue subpixel are arranged horizontally beside each other, such that multicolored lines, wherein every third subpixel have the same color, and monocolored columns are formed on the display. This stripe-arrangement implies a simple array design, simple fabrication procedures and simple driving circuitry, but a poor color homogeneity.

According to prior art, the stripe-arrangement can be modified into a mosaic-arrangement, by offsetting the subpixels by one column compared to the two surrounding rows. This implies a simple array design and a better color homogenity, but also a more difficult fabrication process and a more complex driving circuitry.

Alternatively, the stripe-arrangement is modified into a delta nabla configuration, by offsetting the subpixels in every second row by the with of one and a half subpixel. This implies an even better color homogenity and a simple driving circuitry, but at the cost of a more difficult fabrication procedure and a more complex array design.

In order to meet commercial demands there is a constant aim to produce image display systems, which project brighter pictures with better sharpness and improved homogeneity.

One object of the invention is to provide a display which eliminates or at least alleviates the above described problems.

The present invention relates to the field of displays in general, and in particular to pixelated displays such as liquid crystal displays (LCD), plasma display panels (PDP), organic light emitting displays (OLED) as well as polymer light emitting diode (PLED) displays, field emission displays (FED) and foil displays.

The present invention is based on an insight that by repeatedly forming the following cross-shaped element of two differently colored subpixels:

| | | |
|---|---|---|
| | C2 | |
| C2 | C1 | C2 |
| | C2 | |

on the display, the performance of the display can be improved. C1 is a subpixel emitting a first color, and C2 is a subpixel emitting a second color. C1 and C2 are chosen such that they together are able to generate white light.

One object of the present invention is achieved by a display in accordance with the appended claim 1. Preferred embodiments are defined in the dependent claims.

According to one aspect thereof, the present invention provides a display which comprises an arrangement of subpixels, wherein a first subpixel having a first color is surrounded along a first and a second dimension by adjacent second subpixels, having a second color. The first and second colors are chosen such that they together can form white light. The first and the second dimension can intersect under an arbitrary angle. Further, said first and second directions are not necessarily straight lines.

One advantage associated with the above mentioned aspect of the invention is that white light can be generated along two dimensions, with the use of only two types of subpixels. Another that the area of said first subpixel can be made smaller than the total area of said surrounding subpixel, in order to compensate for a undesirably low perceived brightness of said surrounding subpixels.

Advantageously, said two dimensions are orthogonal, as this facilitates the generation of white along rows and columns of the display.

Advantageously, at least one of said second subpixels is arranged between a third subpixel having a third color and a fourth subpixel having a fourth color along one of said dimensions. Said third and fourth subpixels are chosen such that they together with said second subpixel are able to emit light which is perceived as white. This enables the generation of white light along an additional line. This is further improved if each of said second subpixels is arranged between a subpixel having said third color and a subpixel having said fourth color, along one of said two dimensions.

Preferably, said first color is yellow and said second color is blue, as a large area of blue subpixels can compensate for the reduced sensitivity of the human eye to radiation energy which is perceived as blue. Moreover, the combination of blue and yellow subpixels is advantageous with respect to PolyLED displays. At present when making PolyLED displays it is difficult to make blue subpixels with sufficient life time, as well as making efficient red subpixels. On the other hand, it is possible to make a yellow subpixel, which is very bright and has a very long life time, e.g. twice as long compared to the life time of the produced red and green subpixels. Therefore, the use of a yellow subpixel can compensate the inefficiency of a red subpixel. Moreover, by using a higher number of blue subpixels the statistical probability that at least one them will last a certain amount of time is increased.

Advantageously, one of said blue subpixels is arranged between a red subpixel and a green subpixel along one of said dimensions, e.g. like this:

| | | |
|---|---|---|
| R | B | |
| B | Y | B |
| G | B | |

wherein the pixel in the center is yellow (Y). Hence white light can be generated not only by the cross-shaped element, but also by the left row of the pixel. Alternatively, all of said blue subpixels can be arranged between a red and a green subpixel, respectively. A subpixel arrangement according to this embodiment would be:

| | | |
|---|---|---|
| R | B | G |
| B | Y | B |
| G | B | R |

This provides the possibility of generating white light in three different rows and three different columns of the pixel. The more possibilities there are to generate white light along different rows or columns in a pixel, the sharper is the pixel perceived, under the assumption that the size of the pixel is kept constant. Additionally, subpixels of the same color are spaced well apart, such that the pixels are perceived as more homogenous.

When a four color display is used, color conversion is needed to convert a 3-color image/video signal (RGB, YUV etc.) to the four colors needed by the display (RGBY). This is known to a man skilled in the art.

The subpixels can have any shape, although not all of them are practical when it comes to manufacturing. In an arrangement containing symmetrical pixels, i.e. pixels which have equally arranged rows and columns, the pixels are preferably square. Rectangular pixels are preferably used when the pixels are asymmetric. The subpixels should be sized such that the overall color of the display is white, e.g. color temperature D65.

Advantageously all subpixels, which have the same color and which belong to the same cross-shaped element are controlled by the same control signal. If two adjacent cross-shaped elements have one subpixel in common, the control signals have to be adjusted accordingly, preferably such that both cross-shaped elements can be controlled independently of each other.

The gist of the invention is to arrange the subpixels such that differently colored subpixels are homogenously distributed. Further the subpixels are arranged such that they together generate white light along as many directions of a pixel as desired, with regard to e.g. manufacturing cost. This is preferably achieved by arranging two complementary colored subpixels in an cross-shaped fashion, distributing said cross-shaped element over a display surface and fill the empty positions between the cross-shaped elements with red and green subpixels.

These and other aspects of the invention will be apparent from, and elucidated with reference to, the embodiments described hereinafter.

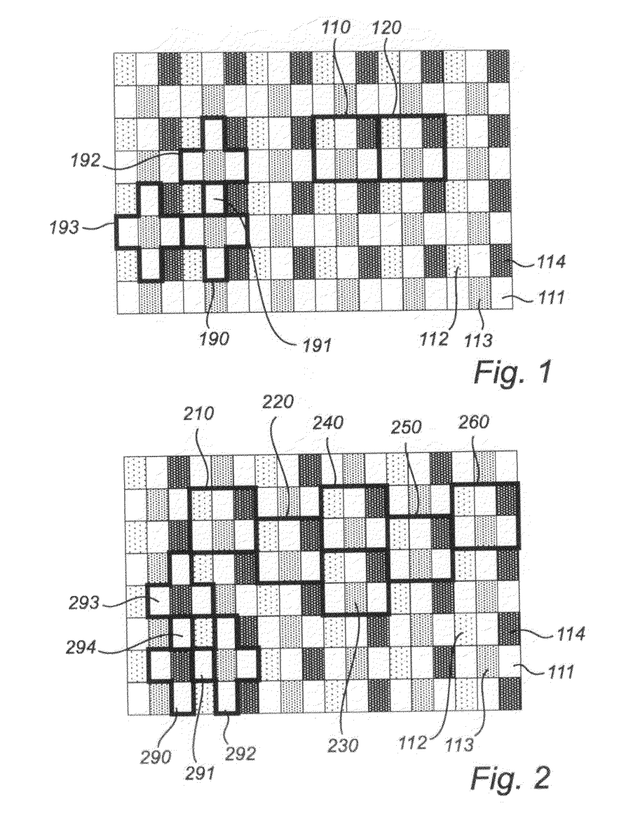

FIG. 1 is a schematic illustration of sub-pixels in a four color display according to one embodiment of the invention.

FIG. 2 is a schematic illustration of sub-pixels in a four color display according to another embodiment of the invention.

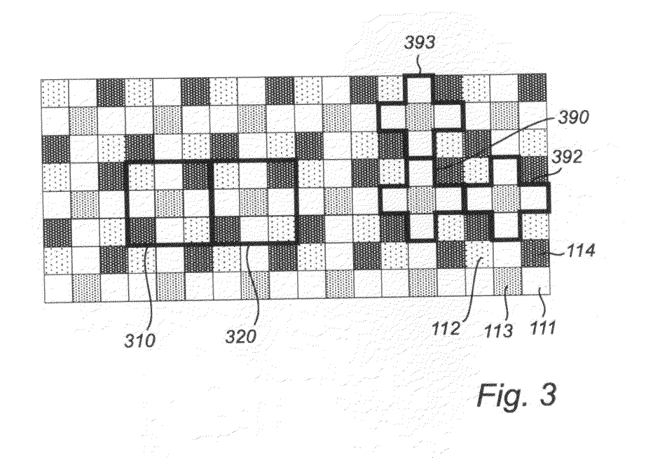

FIG. 3 is a schematic illustration of sub-pixels in a four color display according to a third embodiment of the invention.

Common for all inventive pixel layouts is that when they are distributed over the display a number of cross-shaped elements of blue and yellow subpixels are formed on the display.

According to a first embodiment the following type of pixel (10) is used:

| | | |
|---|---|---|
| G | B | R |
| B | Y | B |

Hence, a blue subpixel is arranged between a green subpixel and a red subpixel in a first row, and a yellow subpixel is arranged between two blue subpixels in an adjacent second row, such that the yellow subpixel is arranged adjacent to said blue subpixel in said first row. As can be seen in FIG. 1 the pixel 110 is repeated on the display in a grid like pattern, such that in each column of the display every second subpixel is blue 111. The other subpixels are either green 112, yellow 113 or red 114, and arranged such that there are only two alternating colors in each column. In other words each column comprises blue subpixels together with either green, yellow or red subpixels. Moreover, every third column comprises yellow and blue subpixels, and such a column is always arranged between a column comprising red subpixels and a column comprising green subpixels. Likewise, every third column comprises red and blue subpixels, and such a column is always arranged between a column comprising yellow subpixels and a column comprising green subpixels. Every second row of the display comprises a repeated sequence of three subpixels with constant order, wherein a blue subpixel is arranged between a green subpixel and a red subpixel. In the remaining rows yellow and blue subpixels are arranged such that two blue subpixels are arranged between two yellow subpixels, and a yellow subpixels is arranged between two blue subpixels. A cross-shaped element is for example formed by the yellow and the three blue subpixels belonging to one pixel and a fourth blue subpixels below the yellow subpixel. Two neighboring cross-shaped elements 190, 193 in the same column have one blue subpixel in common 194. Two neighboring cross-shaped elements in the same row 190, 192 do not have any common blue subpixel. In an alternative embodiment the positions of the red and green subpixels are exchanged in every fourth row (e.g. row 1, 5, 9 . . . ) such that white can be generated in every row and column.

A second embodiment is equal to said first embodiment, which was described in relation to FIG. 1, except for the fact that the pixel 110 is displaced by one row for every set of three columns, this is illustrated by pixel 210, 220 and 230 in FIG. 2. As the height of a pixel is two rows, displacement of every set of three columns equals off-setting every second pixel 220, 250 by one row compared to the neighboring pixels to the left and right 210, 220, 260 of the displaced pixel. In contrast to said first embodiment, all four colors are present in each row of the display. On the other hand, each column only comprises two different colors in the same way as was described in relation to FIG. 1. The cross-shaped element is formed as described in relation to FIG. 1, except for the fact that in this embodiment to neighboring cross-shaped elements 290, 292, 293 have one blue subpixel 291; 294 in common.

In a third embodiment, as illustrated in FIG. 3, the pixel comprises three rows and three columns, and the subpixels are arranged as follows:

| | | |
|---|---|---|
| G | B | R |
| B | Y | B |
| R | B | G |

The pixels are repeated on the display side by side in a grid like fashion, as described in relation to FIG. 1, such that every third row and every third column comprises only blue and yellow subpixels. All other rows and columns comprise a repeated set of one red, one green and one blue subpixel. Moreover, a complete cross-shaped element is formed in each pixel. Hence, neighboring cross-shaped elements 390, 392, 393 do not have any blue subpixels in common.

The pixels which were described in relation to FIGS. 1 and 2 are asymmetric and the subpixels are rectangular, whereas the pixel described in relation to FIG. 3 is symmetric and the subpixels are square.

The illustrated arrangements of the pixels in the displays should not be considered to constitute a limitation, since pixels and sub-pixels may be of various regular or irregular shapes and arranged in a variety of regular or irregular patterns.

The display according to the present invention may, for example, be realized as a separate, stand-alone unit, or may alternatively be included in, or combined with, a mobile terminal for a telecommunications network, such as GSM, UMTS, GPS, GPRS or D-AMPS, or another portable device of an existing type, such as a Personal Digital Assistant(PDA), palmtop computer, portable computer, electronic calendar, electronic book, television set or video game control, as well as various other office automation equipment and audio/video machinery, etc.

The display can also be transposed such that what in this text is true for a row is valid for a column of the transposed display.

The invention has mainly been described with reference to main embodiments. However, embodiments other than the ones disclosed above are equally possible within the scope of the invention, as defined by the appended patent claims. All terms used in the claims are to be interpreted according to their ordinary meaning in the technical field, unless explicitly defined otherwise herein. All references to “a/an/the [element, means, component, member, unit, step etc.]” are to be interpreted openly as referring to at least one instance of said element, means, component, member, unit, step etc. The steps of the methods described herein do not have to be performed in the exact order disclosed, unless explicitly specified.

1. A display comprising an arrangement of subpixels, wherein a first subpixel, having a first color (113), is surrounded along a first dimension and a second dimension by adjacent second subpixels, having a second color (111), wherein said first color and second color together are able to emit light which is perceived as white.

2. A display according to claim 1, wherein said first dimension and second dimension are orthogonal to each other.

3. A display according to claim 1, wherein at least one of said second subpixels is arranged between a third subpixel and a fourth subpixel along one of said dimensions, which third subpixel has a third color (112), and which fourth subpixel has a fourth color (114), wherein said second, third and fourth colors together are able to generate light which is perceived as white.

4. A display according to claim 3, wherein all of said second subpixels are arranged between two subpixels, along said first dimension or said second dimension, respectively, wherein a first of said two subpixels has said third color (112) and a second of said two subpixels has said fourth (114) color.

5. A display according to claim 3, wherein said first (113) color is yellow, and said second color (111) is blue.

6. A display according to claim 4, wherein said first color (113) is yellow, said second color (111) is blue, said third color (112) is red and fourth color (113) is green.

7. A display according to claim 1, wherein all of said subpixels are equally sized and have a quadrangular shape.

8. A display according to claim 1, wherein said second subpixels are controllable by a single control signal.
